(19) United States
(12) Patent Application Publication
(10) Pub. No.: US 2005/0228700 A1
(43) Pub. Date: Oct. 13, 2005

(54) Method and system for settling a patient's medical claim

(76) Inventor: Craig Barcomb, Sarasota, FL (US)

Correspondence Address: Mark D. Swanson;Pauley Petersen & Erickson, Suite 365, 2800 West Higgins Road, Hoffman Estates, IL, 60195, US

(21) Appl. No.: 11/014,046

(22) Filed: Dec. 16, 2004

Related U.S. Application Data
(60) Provisional application No. 60/561,740, filed on Apr. 13, 2004.

(51) Int. Cl. G06F 17/60

(52) U.S. Cl. 705/4

(57) ABSTRACT

A method and system for settling a patient medical claim from a healthcare provider. Medical claim information is received from the healthcare provider by an administrator on behalf of the patient's insurance company. A first monetary amount owed to the healthcare provider and a second monetary amount owed to the patient from the insurance company are determined. Using conventional bank card transaction settlement systems, the first monetary amount owed to the healthcare provider is debited from a credit line of the patient and deposited in a financial account of the healthcare provider to settle the patient medical claim. The second monetary amount is credited to the credit line of the patient by the insurance company.

### CROSS REFERENCE TO RELATED APPLICATION

This application claims priority to U.S. provisional application, Ser. No. 60/561,740, filed on 13 Apr. 2004. The co-pending provisional application is hereby incorporated by reference herein in its entirety and is made a part hereof, including but not limited to those portions which specifically appear hereinafter.

### FIELD OF THE INVENTION

This invention relates generally to a method and system for settling a patient medical claim from a healthcare provider and, more particularly, to a method and system for settling a patient medical claim from a healthcare provider using a bank card transaction settlement system, e.g., a credit card network.

### BACKGROUND OF THE INVENTION

Recently, healthcare benefit administration costs have generally been greatly increasing. In addition, the time frame for a healthcare provider to receive payment from a third party payor, e.g., an insurance company, is larger than desired due, at least in part, to the increasing number and complexity of patient medical claims. The healthcare provider may wait up to several months to receive payment from a patient's insurance company. At that point, the healthcare provider must seek any remainder of the amount owed from the patient. By not collecting a full amount due at the point of service, the healthcare provider typically increases the chance of patient nonpayment. In addition, some patients may request periodic payments as they cannot make a one time payment, thereby again delaying full payment.

Attempting to reduce the likelihood of nonpayment, and increase the timeliness of full payment, many healthcare providers accept credit card payments. By accepting credit cards, the healthcare provider generally receives faster, guaranteed payment from the credit card issuing bank. In addition, the healthcare provider turns the responsibility of collection for the debt over to the issuing bank.

Computer systems and benefit administration outsourcing have been utilized to increase the speed of medical claim processing and lower administration costs. However, there is still a need for an improved medical claim settlement system. There is a need for a medical claim settlement system that provides fast, reliable payment to the healthcare provider and lowers administration costs for the insurance company.

### SUMMARY OF THE INVENTION

A general object of the invention is to provide an improved method and system for settling a patient medical claim from a healthcare provider.

A more specific objective of the invention is to overcome one or more of the problems described above.

The method and system of this invention incorporate bank card transaction settlement systems, such as, for example, a business to business/corporate card system or a consumer card system, to relatively quickly and efficiently settle medical claims with healthcare providers. Administrative staff and/or computer software are/is used for reviewing a medical claim, the insurance plan information, claim settling information, and/or medical service repricing information (according to a provider network pricing agreement) to determine a monetary amount owed to the healthcare provider for the services provided. Payments, billing, fund transfer and/or settlement, and reporting all utilize bank card transaction settlement systems, e.g., the MasterCard® credit card network. The result is a closed loop medical claim payment system that results in low fraud potential, and relatively quick, efficient payment for the healthcare provider, and the benefits of the bank card industry for the patient and any third party medical benefit provider, e.g., an insurance company. In addition, administration costs are typically lowered for the third party medical benefit provider by the method and system of this invention.

The general object of the invention can be attained, at least in part, through a method of settling a patient medical claim from a healthcare provider. The method comprises receiving medical claim information from the healthcare provider, determining a monetary amount owed to the healthcare provider for the medical claim, and depositing the monetary amount in a merchant account of the healthcare provider to settle the patient medical claim.

In contrast to method in accordance with this invention, the prior art generally fails to utilize the bank card industry to provide a reliable, efficient method for settling a medical claim from a healthcare provider.

The invention further comprehends a method of settling a patient medical claim from a healthcare provider comprising receiving medical claim information from the healthcare provider, repricing at least one medical service of the medical claim to determine a monetary amount owed to the healthcare provider, electronically debiting at least a portion of the monetary amount owed to the healthcare provider from a credit line of the patient, and electronically depositing the monetary amount in an account of the healthcare provider to settle the medical claim.

The invention still further comprehends a method of settling a patient medical claim from a healthcare provider comprising receiving medical claim information from the healthcare provider, determining a first monetary amount owed to the healthcare provider, determining a second monetary amount owed to the patient from an insurance company, debiting the first monetary amount owed to the healthcare provider from a credit line of the patient, depositing the first monetary amount in a financial account of the healthcare provider to settle the patient medical claim, and crediting the second monetary amount to the credit line of the patient.

The invention still further comprehends a system for settling a medical claim from a healthcare provider incurred by a patient. The system comprises a patient identification card linked to a bank card issued by a financial institution. An administrator central processing unit receives insurance card information and medical claim information from the healthcare provider. The administrator central processing unit includes computer software code segments which, when executed, determine a monetary amount owed to the healthcare provider for the medical claim. A first transmitter sends a first electronic funds transfer message to the financial institution. The invention further includes a credit line at the financial institution and associated with the bank card. The monetary amount owed to the healthcare provider for the medical claim is electronically debited from the credit line. A financial account of the healthcare provider electronically receives the monetary amount owed to the healthcare provider to settle the medical claim. A second transmitter sends settled medical claim information to a central processing unit located at an insurance company. Upon receiving the settled medical claim information, the insurance company credits a monetary amount owed to the patient under an insurance contract to the credit line.

Other objects and advantages will be apparent to those skilled in the art from the following detailed description taken in conjunction with the appended claims and drawings.

### BRIEF DESCRIPTION OF THE DRAWINGS

FIG. 1 is a block flow diagram illustrating a method according to one embodiment of this invention. In FIG. 1, the patient is a member of a discount medical services plan.

FIG. 2 is a block flow diagram illustrating a method according to another embodiment of this invention. In FIG. 2, the patient is insured by a medical insurance plan from an insurance company.

FIG. 3 illustrates a medical claim settlement system according to one embodiment of this invention. In FIG. 3, the patient is a member of a discount medical services plan.

FIG. 4 illustrates a medical claim settlement system according to another embodiment of this invention. In FIG. 4, the patient is insured by a medical insurance plan from an insurance company.

### DEFINITIONS

Within the context of this specification, each term or phrase below will include the following meaning or meanings.

As used herein, references to “healthcare provider” or “provider” are to be understood to include any person or entity that provides medical services, including, without limitation, diagnosis and treatment or illness, injury, or disease. Examples of healthcare providers include, without limitation, doctors, dentists, nurses, outpatient clinics, MRI or other radiology clinics, emergency service clinics, laboratory testing facilities, and hospitals.

The term “patient” refers to someone receiving medical services from a healthcare provider.

References to “closed loop” or a “closed loop system” are to be understood to describe payment systems or transaction settlement systems using a payment mechanism, e.g., a credit card, that is only acceptable at a merchant, e.g., a healthcare provider, who is authorized to accept such payment mechanism. The use of the payment mechanism is governed by a “closed loop” of contracts defining responsibilities of each of the consumer patient, the issuing bank, the payment card company, e.g., MasterCard®, the acquiring bank, and the merchant healthcare provider.

References herein to “issuing bank” are to be understood to refer to financial institutions that establish, hold, and/or maintain a credit line, and more particularly a credit line associated with a bank card. Issuing banks are known and available in the art to provide consumer access to the credit card industry, i.e., the ability to have and use a credit card, by providing the consumer with an unsecured line of credit. In the method and system of this invention, the patient is the consumer.

References herein to “acquiring bank” or “merchant bank” are to be understood to refer to financial institutions that establish, hold, and/or maintain a merchant access to the credit card industry, i.e., the ability to accept payment by credit cards. The acquiring, or merchant, bank typically debits the consumer's credit line at the issuing bank and deposits the funds into the merchant's account.

References herein to “merchant account” are to be understood to refer to accounts established, held, and/or maintained by a financial institution on behalf of a healthcare provider merchant for receiving deposits from a credit line of a patient consumer.

References herein to “ACH” or “Automated Clearing House” are to be understood to refer to the presently available system of electronic transfer of funds between financial institutions.

These terms may be defined with additional language in the remaining portions of the specification.

### DETAILED DESCRIPTION OF THE PRESENTLY PREFERRED EMBODIMENTS

The invention relates to a method of settling a patient's medical claim, and a system for settling the medical claim. The method of this invention generally provides relatively quick, efficient medical claim processing coupled with a closed loop transaction settling system, such as, for example, a business-to-business or consumer card transaction system (e.g., a credit card transaction system). The method of one embodiment of this invention is a closed loop medical claim transaction settlement system that incorporates a credit card network, i.e., a credit card fund settling system. The credit card network is utilized for transferring money for payment of medical claims and/or insurance benefit payments. The method and system of this invention simplify and increase efficiency between a patient, a healthcare provider, and a third party medical benefit provider, such as, for example, an insurance company or a discount medical service program.

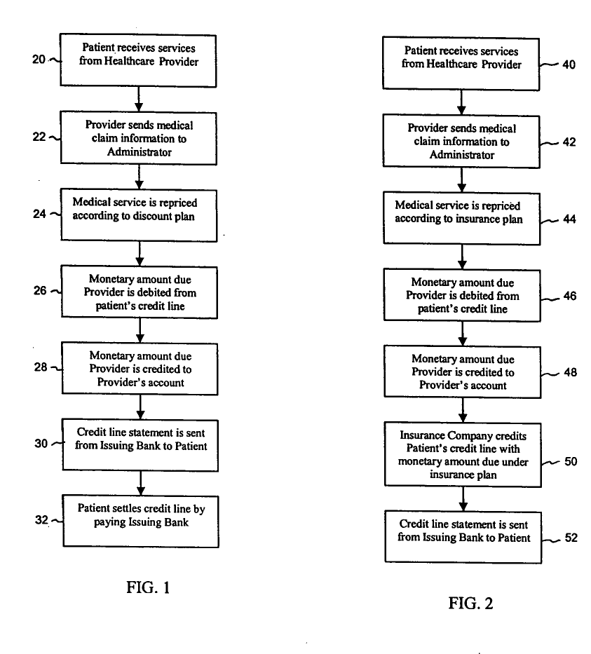

FIG. 1 is a flow chart illustrating a method of settling a patient medical claim according to one embodiment of this invention. The method illustrated in FIG. 1 represents an embodiment of this invention where a patient does not have insurance benefits, but is entitled to a discount for a medical service performed by the healthcare provider pursuant to the patient's membership in a discount medical service program. The patient's membership in the discount services plan provides discounts for medical services provided at accepting healthcare providers. In step 20, the patient receives services from a healthcare provider. In the embodiment of this invention shown in FIG. 1, the healthcare provider participates in or accepts the discount medical service program of which the patient is a member.

At the point of service, step 20, the patient gives the healthcare provider the appropriate identification, such as an identification card provided by the discount medical service program, for notifying the healthcare provider of the patient's membership in the discount medical service program. In step 22, pursuant to instructions that are desirably detailed on the identification card, the healthcare provider submits medical claim information to be received by an administrator. As used herein, the “administrator” can be, without limitation, either the owner/provider of the discount medical service program or a third party administrator contracted with or hired by the owner/provider of the discount medical service program to administer plan benefits. The medical claim information desirably includes, without limitation, information about the services performed, including the date and type of services, and the costs claimed by the healthcare provider for performing the services. In one preferred embodiment of the invention, the services provided are coded by standardized procedural codes according to medical coding systems known and available in the art. The submission of the medical claim information is desirably done electronically, such as over the Internet.

In step 24, the administrator reviews the medical claim information and determines a monetary amount owed to the healthcare provider for the medical claim. The monetary amount owed to the healthcare provider is determined according to the pricing plan of the discount medical service program accepted by the healthcare provider. In one embodiment of this invention, determining the monetary amount owed to the healthcare provider comprises repricing medical services according to or using at least one procedural code.

In step 26, the monetary amount determined by the administrator to be owed to the healthcare provider is debited from a credit line of, i.e., in the name of, the patient. In one particularly preferred embodiment, such as shown in FIG. 1, the patient's credit line is a credit line established solely for the purpose of paying medical claims submitted under the discount medical service program. The credit line is desirably established by a financial institution, such as, and referred to below as, an issuing bank, in cooperation with the administrator on behalf of the patient. In one embodiment of this invention, the credit line is established when the patient enrolls in the discount medical service program. In another embodiment of this invention, the credit line is established at the issuing bank by the administrator upon receiving the medical claim information. In one embodiment of this invention, the credit line is available only for payment of medical services through the administrator.

The monetary amount debited from the patient's credit line is deposited in an account of the healthcare provider in step 28, thereby settling the medical claim. The debiting and depositing are desirably done electronically. In one embodiment of this invention, transferring of the monetary amount from the patient's credit line to the healthcare provider's account is performed utilizing a transaction settlement system available in the bank card industry, and desirably a credit card network. The credit line is provided by an issuing bank and the money is deposited into a merchant account of the healthcare provider at an acquiring bank.

In one embodiment of this invention, the merchant account can be an account already established and operated by the healthcare provider for accepting credit card payments independent of the method of this invention. In another embodiment of this invention, a merchant account is established for the healthcare provider by the administrator and the issuing bank upon receiving the medical claim information. Thus, in one embodiment of the invention, a single financial institution provides both the credit line and the healthcare provider's merchant account. In other words, the financial institution acting as the issuing bank for the administrator also acts as the acquiring bank for the healthcare provider. The funds in the healthcare provider's merchant account at the acquiring bank are available to be further electronically transferred, such as, for example, by ACH electronic funds transfer, to another account in the name of the healthcare provider, such as, for example, a second merchant account at a second financial institution or a corporate checking account.

In yet another embodiment of this invention, the monetary amount debited from the patient's credit line is, in step 28, deposited to an administrative account, e.g., an account owned and controlled by the administrator, before being deposited in an account of the healthcare provider to settle the medical claim. The debiting and depositing are desirably done electronically, although the monetary amount can be deposited to the healthcare provider's account by other means, such as, for example, by paper check. The monetary amount is desirably electronically deposited in the account of the healthcare provider, e.g., the healthcare provider's checking, savings, or other corporate account, by ACH funds transfer from the administrative account. In one embodiment of this invention, the administrative account is a merchant account of an administrator. The merchant account can desirably be provided by the financial institution providing the credit line.

As will be appreciated by one skilled in the art following the teachings herein provided, variations in the procedures and processes for electronic routing of funds are available for the method and system of this invention, particularly as the method and system of this invention are available to operate in conjunction with various bank card networks.

The credit line is desirably both debited and settled by the patient in a manner similar, if not identical, to payment of a typical consumer credit card. In step 30, the issuing bank sends a statement to the patient reporting the amount owed to the issuing bank. The amount owed by the patient to the issuing bank is equal to the amount paid by the issuing bank (from the patient's credit line) to the healthcare provider. In step 32, the patient settles the credit line by paying the issuing bank.

The method of this invention provides the advantages of the credit card payment to both the healthcare provider and the patient. For example, the healthcare provider is assured of relatively fast, reliable, on-time payment without having to separately bill the patient. The patient receives the benefits of the discount medical service program without having to pay the healthcare provider at the point of service. In addition, the patient generally receives quicker benefit determination and typically receives the benefits of the grace period provided by credit card issuing banks for payment, thereby allowing delayed payment, interest free, for a predetermined period, such as, for example, up to about a month. The credit line also provides the patient with the ability to pay off the debt over a longer time frame, generally with interest accruing.

FIG. 2 illustrates a method of settling a patient medical claim from a healthcare provider according to another embodiment of this invention. In the method illustrated in FIG. 2, the patient seeking medical service is covered by medical insurance. In step 40, the patient goes to a healthcare provider, generally desirably a healthcare provider within an insurance network of the patient's insurance company, and receives medical services. At the point of service, the patient provides the healthcare provider with an insurance card or otherwise notifies the healthcare provider of the patient's insurance coverage. In one embodiment of this invention, the insurance card instructs the healthcare provider to submit, in step 42, medical claim information to an administrator. The medical claim information is desirably submitted electronically, such as over the Internet through the administrator's web site. In the embodiment of the invention shown in FIG. 2, the administrator is not the insurance company, but a third party administrator contracted with or hired by the insurance company to perform the method of this invention. However, as will be appreciated by one skilled in the art following the teachings herein provided, the method of this invention is not intended to be limited to the use of a third party administrator, and the administrator can be the patient's insurance company, or a subsidiary of the insurance company.

Upon receiving the medical claim information from the healthcare provider in step 42, the administrator reprices the one or more medical services of the medical claim in step 44. As will be appreciated by one skilled in the art following the teachings herein provided, the medical services are typically repriced according to a pricing agreement between the insurance company and the healthcare provider and/or the patient's insurance plan. By repricing the medical service(s), the administrator determines a monetary amount owed to the healthcare provider for the performed medical service(s). In addition, during the repricing step, the respective amounts owed to the healthcare provider from each of the patient and the insurance company under the patient's insurance plan are also determined. In other words, the fees claimed by the healthcare provider are repriced according to any pricing agreement between the healthcare provider and the insurance company (generally through insurance network contracts). The respective portions of the monetary amount owed to the healthcare provider by each of the patient, if any, and the insurance company, if any, are also desirably determined at this step.

Receiving and repricing the medical claim is desirably performed fully or partially automatically. In one embodiment of this invention, the patient's insurance card information and medical claim information, which is submitted electronically, is received by an administrator central processing unit. The administrator central processing unit includes computer software code segments which, when executed, determine the monetary amount owed to the healthcare provider for the medical claim. The software of the administrator central processing unit desirably matches the patient's medical claim information with the patient's insurance benefits and reprices the medical services, according to the standardized procedural codes, such as are available in the art, to determine the monetary amount owed to the healthcare provider. The software code also desirably determines whether the healthcare provider is a member of the patient's insurance network, and uses this as one factor in determining the monetary amount owed to the healthcare provider. As will be appreciated by one skilled in the art following the teachings herein, one or more or all functions performed by the administrator according to the method of this invention can be performed manually by a person, automatically by a computer, or by combinations thereof, such as, for example, a combination of manual inputs and automatic repricing determinations.

In step 46, upon determining the monetary amount owed to the healthcare provider, the administrator initiates or authorizes debiting of the monetary amount owed to the healthcare provider from a credit line of the patient. In one embodiment of this invention, the administrator central processing unit includes computer software code segments that, upon determining the monetary amount owed to the healthcare provider, automatically initiates or authorizes debiting of the patient's credit line. In step 48, the monetary amount debited from the patient's credit line is deposited, and preferably electronically deposited, in an account of the healthcare provider to settle the medical claim.

In one particularly preferred embodiment of this invention, the transferring of the monetary amount from the patient's credit line to the healthcare provider's account in steps 46 and 48 is performed utilizing transaction settlement systems known in the bank card industry, and desirably a conventional credit card network. The credit line is provided by an issuing bank and the money is deposited into a merchant account of the healthcare provider at an acquiring bank.

As discussed above with reference to FIG. 1, in one embodiment of this invention, the merchant account can be an account already established and operated by the healthcare provider for accepting credit card payments independent of the method of this invention. In another embodiment of this invention, a merchant account is established, such as in step 44, for the healthcare provider by the administrator and the issuing bank upon receiving the medical claim information. Thus, in this embodiment of the invention, a single financial institution provides both the credit line and the healthcare provider's merchant account. In other words, the financial institution acting as the issuing bank for the administrator also acts as the acquiring bank for the healthcare provider. The funds in the healthcare provider's merchant account at the issuing/acquiring bank are available to be further electronically transferred, such as, for example, by ACH funds transfer, to another account in the name of the healthcare provider, such as, for example, a second merchant account at a second financial institution or a corporate checking account.

In yet another embodiment of this invention, the monetary amount debited from the patient's credit line is, in step 28, electronically deposited using the bank card transaction settlement system to an administrative account, e.g., an account owned and controlled by the administrator, before being deposited in an account of the healthcare provider to settle the medical claim. The debiting and depositing are desirably done electronically, although the monetary amount can be deposited to the healthcare provider's account by other means, such as, for example, by paper check. The monetary amount is desirably electronically deposited in the account of the healthcare provider, e.g., the healthcare provider's checking, savings, or other corporate account, by ACH funds transfer from the administrative account. In one embodiment of this invention, the administrative account is a merchant account of an administrator. The merchant account can desirably be provided by the financial institution providing the credit line, thereby simplifying the finds routing system and process.

As will be appreciated by one skilled in the art following the teachings herein provided, variations in the procedures and processes for electronic routing of funds are available for the method and system of this invention, particularly as the method and system of this invention are available to operate in conjunction with diverse bank card networks.

In step 50, the insurance company credits the patient's credit line with a second monetary amount owed to the patient under the patient's insurance plan. As discussed above, the second monetary amount is desirably determined in step 44 when the medical services are repriced and forwarded to the insurance company, along with other details of the claim, by the administrator. The insurance company desirably deposits the money with the issuing bank electronically, such as, for example, by ACH electronic funds transfer.

In step 52, the issuing bank issues a statement describing the account history of the patient's credit line. In one embodiment of this invention, the second monetary amount is equal to the monetary amount debited from the credit line and the statement reflects that no balance is due the issuing bank from the patient and the medical claim has been settled. In another embodiment of this invention, the second monetary amount is less than the monetary amount debited from the patient's credit line. The second monetary amount may be less than the full amount owed the issuing bank on the credit line in situations such as, for example, where the patient owes a co-payment to the healthcare provider, the insurance company pays less than 100 percent under the patient's insurance plan, the patient has a deductible, and/or the healthcare provider was not within the patient's preferred provider network. If the second monetary amount debited to the credit line does not cover the total amount owed to the issuing bank, the statement sent to the patient from the issuing bank will reflect an amount due. The statement desirably includes a description of the medical services provided and an explanation of benefits, however, as will be appreciated, such information may be sent to the patient separately by the administrator or the insurance company. Thus, the method of this invention provides a quick and efficient means to settle a patient's medical claim from a healthcare provider.

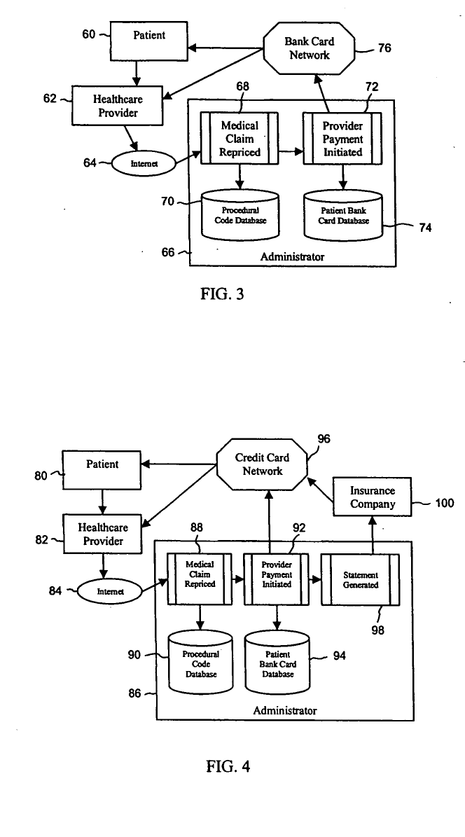

As discussed above, in one particularly preferred embodiment of this invention, a bank card funds routing network is used to establish the patient's credit line and to execute payments. FIG. 3 is a simplified illustration of the operation of a system for settling a medical claim incurred by a patient of a healthcare provider, according to one embodiment of this invention. The system illustrated in FIG. 3 can be used, for example, in performing the method described above with reference to FIG. 1. In one embodiment of this invention, the medical claim settlement system shown in FIG. 3 is a closed loop system, using a bank card network to provide secure, reliable payment to the healthcare provider.

In FIG. 3, the patient 60 has a discount medical service program identification card that is also, is linked to, or is otherwise associated with a bank card, or bank card account, issued by a financial institution. The bank card can be, for example, a debit card or a credit card. As discussed above, the patient visits a healthcare provider 62 for medical services and presents the identification card at the point of service. The healthcare provider performs medical services for the patient, thereby generating a medical claim for payment of those medical services.

Using the information and/or instructions on the patient's identification card, the healthcare provider 62, through the Internet 64, desirably logs onto a web page of an administrator 66. Through the administrator's 66 web page, the healthcare provider enters medical claim information, such as, but not limited to, a patient's identification number from the identification card (and/or other patient identification information), healthcare provider information, and details of the medical services provided. In one embodiment of this invention, the medical services are identified by one or more standardized procedural coding systems, such as are available in the art.

In one embodiment of this invention, an administrator central processing unit receives the patient's identification card information and medical claim information from the healthcare provider. The administrator central processing unit includes computer software code segments which, when executed, determine a monetary amount owed to the healthcare provider for the medical claim. The administrator central processing unit, in step 68, reprices the medical services according to the patient's discount medical service program. The administrator central processing unit reprices the medical services by matching the submitted procedural code(s) to the corresponding discounted pricing for the submitted procedural code(s). The discounted pricing information is maintained in a procedural code database 68.

Upon repricing the medical services, the administrator, through the administrator central processing unit, initiates payment of the healthcare provider on behalf of the patient. In step 72, the administrator central processing unit obtains information on the patient's bank card from bank card information maintained in a database 74. The administrator central processing unit uses a transmitter, such as are known and available in the art, for electronically sending electronic funds transfer message authorizing payment to the healthcare provider though a bank card network 76. The bank card network 76 includes a financial institution that allows the administrator access to the bank card network 76. In one particularly preferred embodiment of this invention, the bank card network 76 is a credit card network, such as, for example, a conventional MasterCard® credit card network, however, as will be appreciated, the broader practice of this invention is not intended to be so limited and can include or incorporate, for example, a debit card network.

When the bank card network 76 is a credit card network, the financial institution in partnership with the administrator is, or operates as a conventional issuing bank for credit card processing, and providing and maintaining a credit line for the patient, from which the healthcare provider is paid. A monetary amount owed to the healthcare provider for the medical claim is electronically debited from the credit line and transferred and credited to a financial account of the healthcare provider. The monetary amount electronically received by the financial account of the healthcare provider settles the patient's medical claim.

When the system of this invention incorporates or utilizes the credit card network, the healthcare provider's financial account is desirably a conventional merchant account, as is generally known and available in the art for receiving credit card payments. The merchant account is maintained by an acquiring bank, which can be the same or different financial institution as the patient's issuing bank. As discussed above, the issuing bank may also act as an acquiring bank on behalf of the healthcare provider in the system and method of one embodiment of this invention. In such an embodiment, the administrator, or the healthcare provider using the administrator's software, establishes a merchant account for the healthcare provider. The monetary amount owed to the healthcare provider is deposited in the merchant account and is available for transfer, such as, for example, by ACH electronic fund transfer, by the healthcare provider to another account.

By utilizing a credit card network, or other bank card network, the administrator, on behalf of the discount medical service program, can quickly and efficiently resolve medical claims on behalf of the patient. Linking or otherwise associating the patient's identification card with a credit line at the issuing bank provides a means for generally quick, reliable settlement of the medical claim, a benefit for the healthcare provider, and the benefits of credit card, or other bank card, payment to the patient. The patient receives a statement of account from the issuing bank and typically receives a grace period for settling the credit line before being subject to interest on the amount owed to the issuing bank.

FIG. 4 is a simplified illustration of the operation of a system for settling a medical claim incurred by a patient of a healthcare provider, according to another embodiment of this invention. The system illustrated in FIG. 4 is similar to the system shown in FIG. 3, except that the patient in the system of FIG. 4 is insured and the system can be used, for example, in implementing or performing the method described above with reference to FIG. 2. The medical claim settlement system shown in FIG. 4 is also a closed loop system, using a credit card network to provide secure, reliable payment to the healthcare provider.

In FIG. 4, the patient 80 has an insurance card that is also, is linked to, or is otherwise associated with, a bank card, or a bank card account, issued by a financial institution. As in the system of FIG. 3, the bank card can be, for example, a debit card or a credit card, but will be described below as a credit card. The patient visits a healthcare provider 82 for medical services and presents the insurance card at the point of service. The healthcare provider performs medical services for the patient, thereby generating a medical claim for payment of those medical services.

Using the information and/or instructions on the patient's insurance card, the healthcare provider 82, through the Internet 84, desirably logs onto a web page of an administrator 86. Through the web page of the administrator 86, the healthcare provider enters medical claim information, such as, but not limited to, a patient's identification number from the insurance card (and/or other patient identification information), healthcare provider information, and details of the medical services provided. In one embodiment of this invention, the medical services are identified by one or more standardized procedural coding systems, such as are available in the art.

In one embodiment of this invention, an administrator central processing unit receives the patient's insurance card information and medical claim information from the healthcare provider. The administrator central processing unit includes computer software code segments which, when executed, determine a monetary amount owed to the healthcare provider for the medical claim. The administrator central processing unit, in step 88, reprices the medical services according to an insurance network pricing agreement between the healthcare provider, who is desirably a contracted member of the insurance network, and the patient's insurance company 100. The administrator central processing unit reprices the medical services by matching the submitted procedural code(s) to the corresponding discounted price for the submitted procedural code(s). The discounted pricing information is stored in a procedural code database 90. As will be appreciated by one skilled in the art following the teachings herein provided, if the healthcare provider is not a member of the patient's preferred network of healthcare providers, the medical services can be repriced according to a usual and customary amount or a maximum allowable amount under the patient's insurance plan or contract.

Upon repricing the medical services, the administrator, through the administrator central processing unit, initiates and/or authorizes payment to the healthcare provider on behalf of the patient. In step 92, the administrator central processing unit obtains information about the patient's bank card account from information maintained in a bank card database 94. The administrator central processing unit uses a transmitter for electronically sending an electronic funds transfer message authorizing payment to the healthcare provider though a bank card network, shown as credit card network 96. The credit card network 96 includes a financial institution that allows the administrator access to the credit card network 96. In one particularly preferred embodiment of this invention, the credit card network 96 is, for example, a MasterCard® credit card network, however, as will be appreciated, the broader practice of this invention is not so limited and can incorporate or include, for example, other third party credit card networks, such as a VISA®, Discover®, or American Express® credit card network.

In the system of FIG. 4, the financial institution associated with, or under contract with, the administrator is, or operates as, a conventional issuing bank for credit card processing and providing and maintaining a credit line for the patient, from which the healthcare provider is paid. A monetary amount owed to the healthcare provider for the medical claim is electronically debited from the credit line and transferred and credited to a conventional merchant account of the healthcare provider, as is generally known in the art for receiving credit card payments. The monetary amount electronically received in the merchant account of the healthcare provider settles the patient's medical claim. The merchant account is maintained by an acquiring bank, which can be the same financial institution as or a different financial institution from the patient's issuing bank.

When the system of this invention incorporates or utilizes the credit card network, the healthcare provider's financial account is desirably a conventional merchant account, as is generally known and available in the art for receiving credit card payments. The merchant account is maintained by an acquiring bank, which can be, as discussed above, the same or a different financial institution from the patient's issuing bank.

In step 98, the administrator central processing unit generates an account statement for sending to the patient's insurance company. The insurance company's account statement, which includes the settled medical claim information, is desirably sent electronically by a second transmitter to a central processing unit located at the insurance company. Upon receiving the settled medical claim information, the insurance company credits a monetary amount owed to the patient to the credit line at the issuing bank. As will be appreciated by one skilled in the art following the teachings herein provided, the insurance company can credit the patient's credit line directly or through the administrator. The amount credited to the patient's credit line by the insurance company is the monetary amount owed to the patient as an insurance benefit under the patient's insurance plan or contract.

By utilizing a credit card network, the administrator, on behalf of the insurance company, can quickly and efficiently resolve both the healthcare provider's medical claims and the patient's insurance claims. Linking or otherwise associating the patient's insurance card with a credit line at the issuing bank provides a means for generally quick, reliable settlement of the medical claim, a benefit for the healthcare provider, and the benefits of credit card payment to the patient. The patient receives a statement of account from the issuing bank and typically receives a grace period for settling the credit line before being subject to interest on the amount owed to the issuing bank.

The method and system of this invention thus provide an improved settlement system for settling a healthcare provider's medical claims, for patients entitled to benefits from a third party benefit provider, e.g., a medical services discount plan or an insurance company. As discussed above, the closed loop system and method of this invention provide generally efficient, reliable payment to the healthcare provider. In addition, the patient receives the benefits of the bank card industry, such as, for example, deferred payment. Also, in particular embodiments of this invention, an outside administrator can be used to lower administration costs of insurance plans and/or discount medical service programs.

While the embodiments of the invention described herein are presently preferred, various modifications and improvements can be made without departing from the spirit and scope of the invention. The scope of the invention is indicated by the appended claims, and all changes that fall within the meaning and range of equivalents are intended to be embraced therein.

1. A method of settling a patient medical claim from a healthcare provider, the method comprising:
receiving medical claim information from the healthcare provider;
determining a monetary amount owed to the healthcare provider for the medical claim; and
depositing the monetary amount in a merchant account of the healthcare provider to settle the patient medical claim.

2. The method according to claim 1, additionally comprising debiting at least a portion of the monetary amount owed to the healthcare provider from a credit line of the patient.

3. The method according to claim 2, additionally comprising establishing the credit line upon receiving medical claim information from the healthcare provider.

4. The method according to claim 1, additionally comprising establishing the merchant account upon receiving medical claim information from the healthcare provider.

5. The method according to claim 4, wherein one financial institution provides both the credit line and the merchant account.

6. The method according to claim 2, wherein debiting and depositing are done electronically.

7. The method according to claim 2, wherein the patient settles the credit line with a financial institution providing the credit line.

8. The method according to claim 2, additionally comprising:
determining a second monetary amount owed to the patient from an insurance company; and
crediting the second monetary amount to the credit line of the patient.

9. The method according to claim 8, wherein the second monetary amount is equal to the monetary amount debited from the credit line.

10. The method according to claim 2, wherein the medical claim information includes information from an insurance card of the patient, and the insurance card is associated with the credit line.

11. The method according to claim 1, wherein determining the monetary amount owed to the healthcare provider comprises repricing medical services according to a pricing contract.

12. The method according to claim 11, wherein the medical services are repriced according to at least one procedural code.

13. The method according to claim 1, wherein the medical claim information is sent electronically by the healthcare provider.

14. A method of settling a patient medical claim from a healthcare provider, the method comprising:
receiving medical claim information from the healthcare provider;
repricing at least one medical service of the medical claim to determine a monetary amount owed to the healthcare provider;
electronically debiting at least a portion of the monetary amount owed to the healthcare provider from a credit line of the patient; and
electronically depositing the monetary amount in an account of the healthcare provider to settle the medical claim.

15. The method according to claim 14, wherein the at least one medical service is repriced according to a pricing agreement.

16. The method according to claim 15, wherein the at least one medical service is repriced according to at least one procedural code.

17. The method according to claim 15, wherein the patient settles the credit line with a financial institution providing the credit line.

18. The method according to claim 15, additionally comprising:
determining a second monetary amount owed to the patient from an insurance company; and
crediting the second monetary amount to the credit line of the patient.

19. The method according to claim 18, wherein the second monetary amount is equal to the monetary amount debited from the credit line.

20. The method according to claim 14, additionally comprising electronically depositing the monetary amount to an administrative account before electronically depositing the monetary amount in the account of the healthcare provider.

21. The method according to claim 20, wherein the monetary amount is electronically deposited in the account of the healthcare provider by ACH funds transfer from the administrative account.

22. The method according to claim 21, wherein the administrative account is a merchant account of an administrator.

23. The method according to claim 22, wherein the financial institution provides both the credit line and the administrative account.

24. A method of settling a patient medical claim from a healthcare provider, the method comprising:
receiving medical claim information from the healthcare provider;
determining a first monetary amount owed to the healthcare provider;
determining a second monetary amount owed to the patient from an insurance company;
debiting the first monetary amount owed to the healthcare provider from a credit line of the patient;
depositing the first monetary amount in a financial account of the healthcare provider to settle the patient medical claim; and
crediting the second monetary amount to the credit line of the patient.

25. The method according to claim 24, wherein the financial account is a merchant account.

26. The method according to claim 25, additionally comprising establishing the merchant account upon receiving medical claim information from the healthcare provider.

27. The method according to claim 26, wherein one financial institution provides both the credit line and the merchant account.

28. The method according to claim 26, wherein determining the first monetary amount comprises repricing medical services according to a pricing agreement.

29. The method according to claim 28, wherein the medical services are repriced according to at least one procedural code.

30. The method according to claim 24, additionally comprising depositing the first monetary amount to an administrative account before depositing the first monetary amount in the financial account of the healthcare provider.

31. The method according to claim 30, wherein the first monetary amount is deposited in the financial account of the healthcare provider by ACH funds transfer from the administrative account.

32. The method according to claim 31, wherein the administrative account is a merchant account of an administrator.

33. The method according to claim 32, wherein one financial institution provides both the credit line and the administrative account.

34. The method according to claim 24, wherein the second monetary amount is equal to the monetary amount debited from the credit line.

35. The method according to claim 24, additionally comprising sending a credit line account statement to the patient.

36. A system for settling a medical claim from a healthcare provider incurred by a patient, comprising:
a patient identification card linked to a bank card issued by a financial institution;
an administrator central processing unit for receiving insurance card information and medical claim information from the healthcare provider, the administrator central processing unit including computer software code segments which when executed determine a monetary amount owed to the healthcare provider for the medical claim;
a first transmitter for sending a first electronic funds transfer message to the financial institution;
a credit line at the financial institution and associated with the bank card, wherein the monetary amount owed to the healthcare provider for the medical claim is electronically debited from the credit line;
a financial account of the healthcare provider for electronically receiving the monetary amount owed to the healthcare provider to settle the medical claim; and
a second transmitter for sending settled medical claim information to a central processing unit located at an insurance company, wherein upon receiving the settled medical claim information, the insurance company credits a monetary amount owed to the patient under an insurance contract to the credit line.
